(19) United States
(12) Patent Application Publication
(10) Pub. No.: US 2026/0159691 A1
(43) Pub. Date: Jun. 11, 2026

(54) Penetrate-layer oil and its preparation method

(71) Applicant: CHANGSHA UNIVERSITY OF SCIENCE AND TECHNOLOGY, Changsha,Hunan (CN)

(72) Inventors: Chaochao Liu, Changsha,Hunan (CN); Shaoxiong Liu, Changsha,Hunan (CN); Songtao Lv, Changsha,Hunan (CN); Weiwei Lu, Changsha,Hunan (CN); Dongdong Ge, Changsha,Hunan (CN); Chengdong Xia, Changsha,Hunan (CN); Jianlong Zheng, Changsha,Hunan (CN)

(21) Appl. No.: 18/707,741

(22) PCT Filed: Aug. 7, 2023
(86) PCT No.: PCT/CN2023/111464

§ 371 Date: May 6, 2024

(30) Foreign Application Priority Data
Nov. 7, 2022 (CN) 202211382526.1

(51) Int. Cl. C08L 95/00

(52) U.S. Cl. CPC C08L 95/00; C08L 2201/56

(57) ABSTRACT

The present invention discloses a penetrate-layer oil and its preparation method. The preparation method includes steps of (step 10) preparing RAP (reclaimed asphalt pavement), and obtaining a filtrate by performing oil stone separation on the RAP with waste bio-oil; (step 20) heating the filtrate and the asphalt with a preset mass ratio at 130-140° C. for 20-40 min respectively, putting the heated filtrate into the heated asphalt, and obtaining a mixture of the filtrate and the asphalt by and stirring for 20-40 min; and (step 30) cooling the mixture to 60-70° C., evenly stirring after slowly putting a penetrant with a preset mass ratio to the asphalt into the mixture, and shearing for 20 to 40 min to obtain the penetrate-layer oil. The present invention aims at providing a green, renewable and cost-effective penetrate-layer oil.

### BACKGROUND OF THE PRESENT INVENTION

### Field of Invention

The present invention relates to the field of road building material technology, and more particularly to a penetrate-layer oil and its preparation method.

### Description of Related Arts

At present, most of the existing high-grade highways adopt the combination of the semi-rigid base and the asphalt surface to pave the road. Based on different materials used in the base and the surface, the strength and modulus of the two are significantly different, so that under the action of large horizontal shear force, the surface is prone to rutting, cracking, pushing, hugging and other diseases. Furthermore, the existing “Technical Specification for Construction of Highway Asphalt Pavements” also clearly stipulates that all types of bases in semi-rigid base asphalt pavements must be sprayed with the penetrate-layer oil.

Currently, there are many types of the commonly used penetrate-layer oil, such as emulsified asphalt penetrate-layer oil and liquid petroleum asphalt penetrate-layer oil. In addition, the gravel, cement, lime, fly ash used in the semi-rigid base are mostly alkaline minerals, and the common cationic emulsified asphalt has weak adhesion to the surface of alkaline minerals, which is unable to play the good bonding effect. At the same time, the surface of the semi-rigid base is too dense, and the demulsification rate of the cationic emulsified asphalt is too fast, resulting in poor penetration effect of emulsified asphalt. Moreover, the storage stability of anionic and non-ionic emulsified asphalt is poor, so they are not used as penetration materials.

The patent CN 103554933A discloses a highly bonding penetrate-layer oil used for cement stabilized macadam base and its preparation method. Through the production process of first modification and then emulsification, the matrix asphalt is modified by adding a modifier and then emulsified to obtain the modified emulsified asphalt S; the matrix asphalt is emulsified after adding a tackifier to obtain the modified emulsified asphalt T; the modified emulsified asphalt S and the modified emulsified asphalt T are compounded at a mass ratio of 1:1 to obtain the high bonding modified emulsified asphalt, that is, the high bonding penetrate-layer oil. The penetrate-layer oil has good permeability and erosion resistance, which is able to effectively prevent water damage.

At the same time, the penetrate-layer oil has good bonding performance, which is able to achieve good interlaminar bonding between the base and the asphalt surface, so as to improve the stress state of the asphalt surface. However, for those skilled in the art, in spite that the modified emulsified asphalt is able to enhance the permeability and bonding performance, it is high in cost and is unable to be popularized and applied in a large area. Therefore, it is urgent to provide a new penetrate-layer oil and its preparation method.

### SUMMARY OF THE PRESENT INVENTION

An object of the present invention is to provide a penetrate-layer oil and its preparation method, so as to solve the problem that the preparation cost of the existing penetrate-layer oil is high.

To achieve the above object, the present invention provides a preparation method a penetrate-layer oil, wherein the preparation method comprises steps of:
(step 10) preparing RAP (reclaimed asphalt pavement), and obtaining an unsaturated filtrate by performing oil stone separation on the RAP with waste bio-oil;
(step 20) heating the filtrate and asphalt with a preset mass ratio at 130-140° C. for 20-40 min respectively, putting the heated filtrate into the heated asphalt, and then obtaining a mixture of the filtrate and the asphalt by evenly stirring for 20 to 40 min; and
(step 30) cooling the mixture to 60-70° C., evenly stirring after slowly putting a penetrant with a preset mass ratio to the asphalt into the mixture, and shearing for 20 to 40 min to obtain the penetrate-layer oil.

Preferably, (step 10) further comprises after obtaining the unsaturated filtrate by performing oil stone separation on the RAP with waste bio-oil, obtaining a saturated filtrate by supersaturating the unsaturated filtrate.

Preferably, a mass ratio of the filtrate to the asphalt in the mixture is in a range of (0.6-1.4):1.

Preferably, the mass ratio of the filtrate to the asphalt in the mixture is 1:1.

Preferably, the penetrant is in a range of 5-30% of the asphalt by mass.

Preferably, the penetrant is 10% of the asphalt by mass.

Preferably, the waste bio-oil is at least one member selected from a group consisting of waste cooking oil, waste edible oil and waste vegetable oil.

Preferably, the penetrant is primary alcohol ethoxylate.

Also, to achieve the above object, the present invention provides a penetrate-layer oil which is prepared by the preparation method according to any one of claims.

Preferably, a penetrate depth of the penetrate-layer oil is more than 5 mm.

The preparation method of the penetrate-layer oil provided by the present invention comprises steps of preparing RAP (reclaimed asphalt pavement), and performing oil stone separation on the RAP with waste bio-oil to obtain a filtrate, wherein the filtrate is used as a solvent in subsequent preparation processes for realizing the recycling, so as to further reduce the cost of raw materials of the penetrate-layer oil. Moreover, the filtrate contains the waste bio-oil which dissolves the aged asphalt, the aged asphalt is able to increase the polar components of the penetrate-layer oil, so that the bonding property between the penetrate-layer oil and the base is significantly improved. Furthermore, the filtrate contains the chemical compositions and structure similar to the asphalt, so that the mixture of the two has good stability. Compared with the traditional solvent of the penetrate-layer oil, the filtrate according to the embodiments of the present invention is low in volatility, which significantly reduces the damage to construction personnel and environment during the construction process. In addition, the penetrate-layer oil is able to significantly enhance the bonding property between the cement stabilized macadam base and the asphalt surface, and significantly improve the continuity of mechanical response of semi-rigid base asphalt pavement, thus reducing the occurrence of corresponding diseases on the road surface.

### BRIEF DESCRIPTION OF THE DRAWINGS

FIG. 1 is a flow chart of a preparation method of a penetrate-layer oil according to an embodiment of the present invention.

The realization of the object, functional characteristics and advantages of the present invention will be further explained in conjunction with embodiments and with reference to the attached drawings.

### DETAILED DESCRIPTION OF THE PREFERRED EMBODIMENT

It should be understood that the specific embodiments described herein are intended only to explain the present invention and are not intended to limit the present invention.

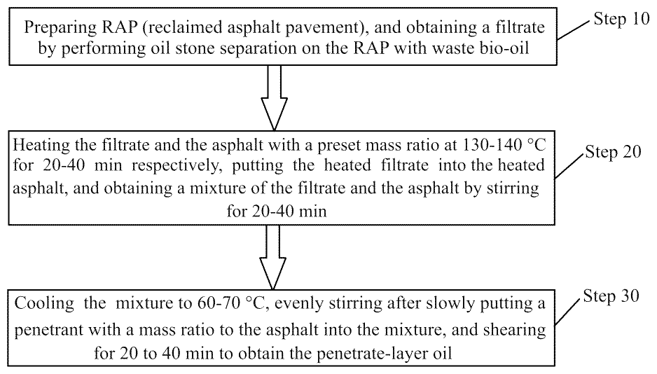

FIG. 1 is a flow chart of a preparation method of a penetrate-layer oil according to a first embodiment of the present invention. The preparation method comprises steps of:
(step 10) preparing RAP (reclaimed asphalt pavement), and obtaining a filtrate by performing oil stone separation on the RAP with waste bio-oil, wherein:
the waste bio-oil is at least one member selected from a group consisting of waste cooking oil, waste edible oil and waste vegetable oil;
generally, the waste cooking oil, the waste edible oil and the waste vegetable oil all of which are recovered by conventional methods are able to be used directly without further treatment, and moreover, the oil stone separation is performed on the RAP by the waste bio-oil with an oil stone separation device for obtaining the filtrate, so the filtrate contains the waste bio-oil, and further, the RAP contains some aged asphalt, the waste bio-oil is able to dissolve a certain amount of the aged asphalt, so the filtrate contains both the waste bio-oil and the certain amount of the aged asphalt which is dissolved by the waste bio-oil;
(step 20) heating the filtrate and asphalt with a preset mass ratio at 130-140° C. for 20-40 min respectively, putting the heated filtrate into the heated asphalt, obtaining a mixture of the filtrate and the asphalt by stirring for 20-40 min, and shearing the mixture at a speed of 3000 r/min for 30 min with a high speed shearing machine for mutually dissolving the filtrate and the asphalt to a uniform state, wherein:
a mass ratio of the filtrate to the asphalt in the mixture is in a range of (0.6-1.4):1, and preferably is 1:1; and
(step 30) cooling the mixture to 60-70° C., evenly stirring after slowly putting a penetrant with a mass ratio to the asphalt into the mixture, and shearing for 20 to 40 min, so as to obtain the penetrate-layer oil, wherein:
the mixture is naturally cooled at room temperature to 60-70° C., the penetrant is slowly put into the mixture and stirred with a glass rod, and then sheared at a speed of 3000 r/min for 30 min to obtain the penetrate-layer oil;
the penetrant is in a range of 5-30% of the asphalt by mass, and preferably, the penetrant is 10% of the asphalt by mass, and preferably, the penetrant is primary alcohol ethoxylate.

The penetrate-layer oil provided by the present invention is prepared by a method, which comprises steps of preparing RAP (reclaimed asphalt pavement), and performing oil stone separation on the RAP with waste bio-oil to obtain a filtrate, wherein the filtrate is used as a solvent in subsequent preparation processes for realizing the recycling, so as to further reduce the cost of raw materials of the penetrate-layer oil. Moreover, the filtrate contains the waste bio-oil which dissolves the aged asphalt, the aged asphalt is able to increase the polar components of the penetrate-layer oil, so that the bonding property between the penetrate-layer oil and the base is significantly improved. Furthermore, the filtrate contains the chemical compositions and structure similar to the asphalt, so that the mixture of the two has good stability. Compared with the traditional solvent of the penetrate-layer oil, the filtrate according to the embodiments of the present invention is low in volatility, which significantly reduces the damage to construction personnel and environment during the construction process.

Further, in order to ensure that a content of the waste bio-oil in the filtrate is kept in a certain range, the filtrate is supersaturated to obtain a saturated filtrate.

Further, in order to better illustrate the specific effect of the penetrate-layer oil provided by the present invention, the penetrate-layer oil is prepared by some embodiments as follows, and the corresponding performances of the penetrate-layer oil are tested, such as penetration depth, shear strength and pull strength.

The performances of the penetrate-layer oil are tested as follows.

The prepared penetrate-layer oil is sprayed on a surface of the cement stabilized macadam base, and an asphalt layer is formed after 36 hours. Through the laboratory penetration test and direct interlaminar shear strength test, the penetrate strength and the interlaminar bonding strength are tested.

During the process of spraying the prepared penetrate-layer oil on the surface of the cement stabilized macadam base, the penetrate-layer oil is controlled in a range of 60 to 80° C. The prepared penetrate-layer oil is sprayed on the surface of the cement stabilized macadam base at about 1 day after the cement stabilized macadam base is formed, and at this time, the surface of the base is slightly dry, the spray amount of the penetrate-layer oil is 1.1 L/m².

Table 1 shows the grading of the cement stabilized macadam base, a cement content of the cement stabilized macadam base is 4.5%, an optimum moisture content is 5.4% and a maximum dry density is 2.88 g/cm³.

TABLE 1
Grading of the cement stabilized macadam base

| | | | | | | | | | | | | |
|---|---|---|---|---|---|---|---|---|---|---|---|---|
| Grain Size | 26.5 | 19 | 16 | 13.2 | 9.5 | 4.75 | 2.36 | 1.18 | 0.6 | 0.3 | 0.15 | 0.075 |
| (mm) | | | | | | | | | | | | |
| Passing Rate | 100 | 82 | 74 | 68.7 | 57.5 | 39.7 | 26.3 | 17.2 | 11.6 | 7.9 | 5.2 | 3.2 |
| (%) | | | | | | | | | | | | |

Through vibrational compaction method, the base pavement materials for the cement stabilized macadam base according to the embodiments of the present invention are used to make test samples. A vibrational frequency of the vibration compaction instrument is 30 Hz, a exciting force thereof is 7.6 KN, and a vibrational compaction time of is 120 s.

Table 2 shows the grading of the asphalt surface. The asphalt concrete surface has a best oil-stone ratio of 4.6%, and a maximum dry density of 2.49 g/cm³.

TABLE 2
Grading of the asphalt surface

| | | | | | | | | | | | | |
|---|---|---|---|---|---|---|---|---|---|---|---|---|
| Grain Size | 26.5 | 19 | 16 | 13.2 | 9.5 | 4.75 | 2.36 | 1.18 | 0.6 | 0.3 | 0.15 | 0.075 |
| (mm) | | | | | | | | | | | | |
| Passing Rate | 100 | 92.6 | 79.2 | 68 | 50.9 | 34 | 25 | 18.5 | 11 | 7.8 | 5 | 4.3 |
| (%) | | | | | | | | | | | | |

The asphalt concrete surface is formed on the cement stabilized macadam base after pavement maintenance by Marshall compaction technology, wherein an amount of the compaction is 75 times.

The indoor penetration depth measurement is performed on the test samples containing different ratios of the penetrate-layer oil on the surface of the cement stabilized macadam base, and the depth measurement is ≥5 mm. The test method comprises steps of detecting the penetration depth of the penetrate-layer oil on the surface of cement stabilized macadam base with vernier caliper, wherein three test samples containing the penetrate-layer oil with different ratios are selected, four points are measured for each test sample with vernier caliper, the average value of the tested data is calculated to determine the average penetration depth.

In the test for interlaminar shear strength between the base and the surface of the composite test sample, a MTS (universal material testing machine) is used to test the interlaminar shear strength between the base and the surface of the composite test sample at a speed of 50 mm/min, in which three test samples with different ratios of the penetrate-layer oil are selected.

In the test for interlaminar pull strength between the base and the surface of the composite test sample, the MTS is used to test the interlaminar pull strength between the base and the surface of the composite test sample at the speed of 50 mm/min, in which three test samples with different ratios of the penetrate-layer oil are selected.

### First Embodiment

(Step 10) The RAP (reclaimed asphalt pavement) is prepared, and oil stone separation is performed on the RAP by waste bio-oil to obtain a filtrate.
(Step 20) The filtrate and the asphalt with a mass ratio of 1:1 are heated at 130-140° C. for 30 min respectively, and then stirred for 30 min after putting the heated filtrate into the heated asphalt, so as to obtain a mixture of the filtrate and the asphalt.
(Step 30) The mixture of the filtrate and the asphalt is cooled to 60-70° C., a penetrant is slowly put into the mixture of the filtrate and the asphalt, evenly stirred, and then sheared for 30 min, so as to obtain the penetrate-layer oil 1, wherein the penetrant is 10% of the asphalt by mass.

By performance test, the penetration depth, the shear strength and the pull strength of the above penetrate-layer oil 1 are 4.0 mm, 0.248 MPa and 0.178 MPa, respectively.

### Second Embodiment

Based on the first embodiment, the penetrant provided by the second embodiment is 15% of the asphalt by mass, and the others are the same as the first embodiment, so as to obtain the penetrate-layer oil 2. By performance test, the penetration depth, the shear strength and the pull strength of the penetrate-layer oil 2 are 5.6 mm, 0.265 MPa and 0.213 MPa, respectively.

### Third Embodiment

Based on the first embodiment, the penetrant provided by the third embodiment is 20% of the asphalt by mass, and the others are the same as the first embodiment, so as to obtain the penetrate-layer oil 3. By performance test, the penetration depth, the shear strength and the pull strength of the penetrate-layer oil 3 are 5.8 mm, 0.245 MPa and 0.178 MPa, respectively.

### Fourth Embodiment

Based on the first embodiment, the penetrant provided by the fourth embodiment is 25% of the asphalt by mass, and the others are the same as the first embodiment, so as to obtain the penetrate-layer oil 5. By performance test, the penetration depth, the shear strength and the pull strength of the penetrate-layer oil are 6.1 mm, 0.241 MPa and 0.165 MPa, respectively.

### Fifth Embodiment

Based on the first embodiment, the penetrant provided by the fifth embodiment is 30% of the asphalt by mass, and the others are the same as the first embodiment, so as to obtain the penetrate-layer oil 5. By performance test, the penetration depth, the shear strength and the pull strength of the penetrate-layer oil 5 are 6.4 mm, 0.232 MPa and 0.158 MPa, respectively.

### First Comparative Example

Based on the first embodiment, the penetrant provided by the first comparative example is 5% of the asphalt by mass, and the others are the same as the first embodiment, so as to obtain the penetrate-layer oil 6. The performance of the penetrate-layer oil 6 is tested, and the results show that the penetration depth, the shear strength and the pull strength of the penetrate-layer oil are 5.3 mm, 0.290 MPa and 0.238 MPa, respectively.

Table 3 shows the penetration depth, the shear strength and the pull strength of the penetrate-layer oil under different ratios of the penetrant to the asphalt according to the first to fifth embodiments and the first comparative example, in which the mass ratio of the filtrate to the asphalt is 1:1.

TABLE 3
Results of performance tests of the penetrate-layer oil
under different ratios of the penetrant to the asphalt

| | Amount of | Amount of | Penetration | Shear | Pull |
|---|---|---|---|---|---|
| | filtrate | penetrant | depth | strength | strength |
| Items | (%) | (%) | (mm) | (MPa) | (MPa) |
| First | 100 | 5 | 4.0 | 0.248 | 0.178 |
| comparative | | | | | |
| example | | | | | |
| First | | 10 | 5.3 | 0.290 | 0.238 |
| Embodiment | | | | | |
| Second | | 15 | 5.6 | 0.265 | 0.213 |
| Embodiment | | | | | |
| Third | | 20 | 5.8 | 0.245 | 0.178 |
| Embodiment | | | | | |
| Fourth | | 25 | 6.1 | 0.241 | 0.165 |
| Embodiment | | | | | |
| Fifth | | 30 | 6.4 | 0.232 | 0.158 |
| Embodiment | | | | | |

As shown in Table 3, under the condition of the mass ratio of the filtrate to the asphalt is 1:1, when the penetrant is 10% of the asphalt by mass, the penetration depth, the shear strength and the pull strength of the penetrate-layer oil are 5.3 mm, 0.290 MPa and 0.238 MPa, respectively; the interlaminar bonding strength of the above penetrate-layer oil is better than that of the penetrate-layer oil prepared according to other mass ratios of the penetrant to the asphalt.

Further, on the basis that the penetrant is 10% of the asphalt by mass, the penetration depth, the shear strength and the pull strength of the penetrate-layer oil are determined by adjusting the amount of the filtrate, which are specifically described as follows.

### Sixth Embodiment

Based on the first embodiment, the mass ratio of the filtrate to the asphalt according to the sixth embodiment is adjusted to 1.2:1, and the others are the same as the first embodiment, so as to obtain the penetrate-layer oil 7. The performance of the penetrate-layer oil is tested, and the results show that the penetration depth, the shear strength and the pull strength of the penetrate-layer oil are 5.8 mm, 0.200 MPa and 0.192 MPa, respectively.

### Seventh Embodiment

Based on the first embodiment, the mass ratio of the filtrate to the asphalt according to the seventh embodiment is adjusted to 1.4:1, and the others are the same as the first embodiment, so as to obtain the penetrate-layer oil 8. The performance of the penetrate-layer oil is tested, and the results show that the penetration depth, the shear strength and the pull strength of the penetrate-layer oil are 6.2 mm, 0.163 MPa and 0.131 MPa, respectively.

### Second Comparative Example

Based on the first embodiment, the mass ratio of the filtrate to the asphalt according to the second comparative example is adjusted to 0.6:1, and the others are the same as the first embodiment, so as to obtain the penetrate-layer oil 9. The performance of the penetrate-layer oil is tested, and the results show that the penetration depth, the shear strength and the pull strength of the penetrate-layer oil are 4.3 mm, 0.329 MPa and 0.261 MPa, respectively.

### Third Comparative Example

Based on the first embodiment, the mass ratio of the filtrate to the asphalt according to the third comparative example is adjusted to 0.8:1, and the others are the same as the seventh embodiment, so as to obtain penetrate-layer oil 10. The performance of the penetrate-layer oil is tested, and the results show that the penetration depth, the shear strength and the pull strength of the penetrate-layer oil are 4.5 mm, 0.311 MPa and 0.247 MPa, respectively.

### Fourth Comparative Example

Based on the first embodiment, the bio-oil is replaced with the existing kerosene for preparing the penetrate-layer oil. The performance of the penetrate-layer oil is tested, and the results show that the penetration depth, the shear strength and the pull strength of the penetrate-layer oil are 6.8 mm, 0.084 MPa and 0.051 MPa, respectively.

Table 4 shows the penetration depth, the shear strength and the pull strength of the penetrate-layer oil under different ratios of the filtrate to the asphalt according to the first, sixth and seventh embodiments and the second to fourth comparative examples, in which the penetrant is 10% of the asphalt by mass.

TABLE 4
Results of performance tests of the penetrate-layer oil
under different ratios of the filtrate to the asphalt

| | Amount of | Amount of | Penetration | Shear | Pull |
|---|---|---|---|---|---|
| | penetrant | filtrate | depth | strength | strength |
| Items | (%) | (%) | (mm) | (MPa) | (MPa) |
| Second | 10 | 60 | 4.3 | 0.329 | 0.261 |
| comparative | | | | | |
| example | | | | | |
| Third | | 80 | 4.5 | 0.311 | 0.247 |
| comparative | | | | | |
| example | | | | | |
| First | | 100 | 5.3 | 0.290 | 0.238 |
| Embodiment | | | | | |
| Sixth | | 120 | 5.8 | 0.200 | 0.192 |
| Embodiment | | | | | |
| Seventh | | 140 | 6.2 | 0.163 | 0.131 |
| Embodiment | | | | | |
| Fourth | | 100 | 6.8 | 0.084 | 0.051 |
| comparative | | | | | |
| example | | | | | |

It is able to be known from Table 4 that according to the second and third comparative examples, the penetrate-layer oil has strong shear strength and pull strength, in which the amount of the filtrate accounts for 60% and 80% of the penetrant respectively, and however, the penetration depth of the penetrate-layer oil is less than 5 mm, which is unable to meet the needs of practical applications. Accordingly, when the mass ratio of the filtrate to the asphalt is adjusted to 1:1 according to the first embodiment, the penetration depth of the penetrate-layer oil is more than 5 mm, both the shear strength and the pull strength are better than those in the sixth and seventh embodiments. Moreover, based on the results of performance tests of the penetrate-layer oil shown in Tables 3 and 4, when the mass ratio of the filtrate to the asphalt is 1:1 and the penetrant is 10% of the asphalt by mass, the obtained penetrate-layer oil has the best interlaminar adhesive property. Therefore, the mass ratio of the filtrate to the asphalt is 1:1, and the penetrant is 10% of the asphalt by mass, which is the best ratio for preparing the penetrate-layer oil.

Moreover, instead of the bio-oil, the existing kerosene is used in the fourth comparative example for preparing the penetrate-layer oil; in spite that the penetration depth of the prepared penetrate-layer oil is more than 5 mm, the shear strength and the pull strength thereof are far below those of the penetrate-layer oil prepared by the bio-oil. Kerosene is volatile and has a certain irritating odor, and it also has a corresponding adverse effect on the environment, so it is not suitable to be used as a raw material for the preparation of the penetrate-layer oil.

It should be noted that, in this specification, the terms “include”, “comprise” or any other variations thereof are intended to cover non-exclusive inclusion, so that a process, method, article or system comprising a set of elements includes not only those elements but also other elements that are not expressly listed or that are inherent to the process, method, article or system. In the absence of further restrictions, an element defined by the sentence “including a . . . ” does not preclude the existence of additional identical elements in the process, method, article, or system comprising the element.

The serial number of the embodiments of the present invention is only for description and does not represent the superiority or inferiority of the embodiments.

The above is only the preferred embodiments of the present invention, and does not limit the protective scope of the present invention. Any equivalent structure or equivalent process transformation made by using the contents of the specification and drawings of the present invention, or directly or indirectly applied in other related technical fields, is equally included in the protective scope of the present invention.

1. A preparation method of a penetrate-layer oil, the preparation method comprising steps of:
(step 10) preparing RAP (reclaimed asphalt pavement), and obtaining an unsaturated filtrate by performing oil stone separation on the RAP with waste bio-oil;
(step 20) heating the filtrate and the asphalt with a preset mass ratio at 130-140° C. for 20-40 min respectively, putting the heated filtrate into the heated asphalt, and obtaining a mixture of the filtrate and the asphalt by stirring for 20-40 min; and
(step 30) cooling the mixture to 60-70° C., evenly stirring after slowly putting a penetrant with a mass ratio to the asphalt into the mixture, and shearing for 20 to 40 min to obtain the penetrate-layer oil.

2. The preparation method of the penetrate-layer oil according to claim 1, wherein (step 10) further comprises after obtaining the unsaturated filtrate by performing oil stone separation on the RAP with waste bio-oil, obtaining a saturated filtrate by supersaturating the unsaturated filtrate.

3. The preparation method of the penetrate-layer oil according to claim 1, wherein in (step 20), a mass ratio of the filtrate to the asphalt in the mixture is in a range of (1-1.4):1.

4. The preparation method of the penetrate-layer oil according to claim 3, wherein the mass ratio of the filtrate to the asphalt in the mixture is 1:1.

5. The preparation method of the penetrate-layer oil according to claim 1, wherein in (step 30), the penetrant is in a range of 10-30% of the asphalt by mass.

6. The preparation method of the penetrate-layer oil according to claim 5, wherein the penetrant is 10% of the asphalt by mass.

7. The preparation method of the penetrate-layer oil according to claim 2, wherein the waste bio-oil is at least one member selected from a group consisting of waste cooking oil, waste edible oil and waste vegetable oil.

8. The preparation method of the penetrate-layer oil according to claim 7, wherein the penetrant is primary alcohol ethoxylate.

9. A penetrate-layer oil which is prepared by the preparation method according to claim 2.

10. The penetrate-layer oil according to claim 9, wherein a penetrate depth of the penetrate-layer oil is more than 5 mm.
